(19) United States
(12) Patent Application Publication
(10) Pub. No.: US 2004/0198447 A1
(43) Pub. Date: Oct. 7, 2004

(54) Mobile terminals programmed with wireless signaling software from a removable memory module and methods of programming the same

(76) Inventor: Anders Larsson, Torna Hallestad (SE)

Correspondence Address: MYERS BIGEL SIBLEY & SAJOVEC, PO BOX 37428, RALEIGH, NC, 27627, US

(21) Appl. No.: 10/382,956

(22) Filed: Mar. 7, 2003

(51) Int. Cl. H04M 1/00

(52) U.S. Cl. 455/558; 455/550.1

(57) ABSTRACT

A mobile terminal includes an interface port, a wireless signaling processor, and at least one memory. The interface port is configured to receive a removable memory module having wireless signaling software. The wireless signaling processor is connected to the interface port to communicate with a received removable memory module, and is configured to transfer the wireless signaling software from the removable memory module to the memory. The wireless signaling processor formats communication signals according to the wireless signaling software for transmission by the mobile terminal over at least one wireless communication channel.

### BACKGROUND OF THE INVENTION

The present invention relates to mobile terminals that communicate over wireless channels and, more particularly, to methods and apparatus for programming mobile terminals.

Wireless terminals, such as cellular radiotelephones, are generally preprogrammed with software in a non-volatile memory before they are shipped by a manufacturer. The software defines a communication protocol by which the wireless terminal may communicate over a wireless communication channel, and can define the operations for accessing an internal phone book, for generating, receiving, and displaying short message service messages, emails, data, digital pictures, and/or video. The software may later be reprogrammed by connecting the wireless terminal to a personal computer, such through a serial cable, and downloading new software. Typically, cellular service providers require that a wireless terminal be taken to an authorized service center or a retailer for programming by a technician.

Manufacturers and service providers may desire to change the software in a wireless terminal to provide a new or modified wireless communication protocol, feature, or application, or to remedy potential or actual problems with the operation of the wireless terminal. After wireless terminals have been sold, especially when they have been sold in volumes of tens or hundreds of thousands, it may be particularly difficult and costly to update the software. Manufacturers have been known to recall thousands of wireless terminals, and to reimburse their customers' purchase price, because the wireless terminals could not be economically reprogrammed.

### SUMMARY OF THE INVENTION

Embodiments of the present invention provide a mobile terminal in which a wireless signaling processor transfers wireless signaling software from a removable memory module to at least one memory in the wireless terminal. The mobile terminal formats communication signals according to the wireless signaling software for transmission by the mobile terminal over at least one wireless communication channel.

Other embodiments of the present invention provide that the wireless signal processor may also format communication signals according to a wireless communication protocol that is defined by the wireless signaling software. The wireless signal processor may establish and/or maintain a communication connection over the wireless communication channel with a base station transceiver according to the wireless communication protocol. In other embodiments, formatting of communication signals may be precluded while the wireless signaling software is transferred from the removable memory module to the memory in the mobile terminal. In still other embodiments, the wireless signaling software on the removable memory module may only be transferred when it is determined to be authentic.

### BRIEF DESCRIPTION OF THE DRAWINGS

FIG. 1 is a schematic block diagram illustrating a mobile terminal communicating with a base station transceiver, the mobile terminal includes a removable memory module according to some embodiments of the present invention;

FIGS. 2 and 3 are flow charts illustrating operations for transferring and using wireless signaling software from a removable memory module according to embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions.

The present invention is described below with reference to flowchart illustrations and/or block diagrams of mobile terminals and removable memory modules according to embodiments of the present invention. It will be understood that each block of the flowchart illustrations and/or schematic block diagrams, and combinations of blocks in the flowchart illustrations and/or block diagrams, can be implemented by radio frequency, analog and/or digital hardware, and/or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or schematic block or blocks. In some alternate implementations, the operations/acts noted in the blocks may occur out of the order noted in the operational illustrations. For example, two blocks shown in succession may in fact be executed substantially concurrently or the blocks may sometimes be executed in the reverse order, depending upon the operations/acts involved.

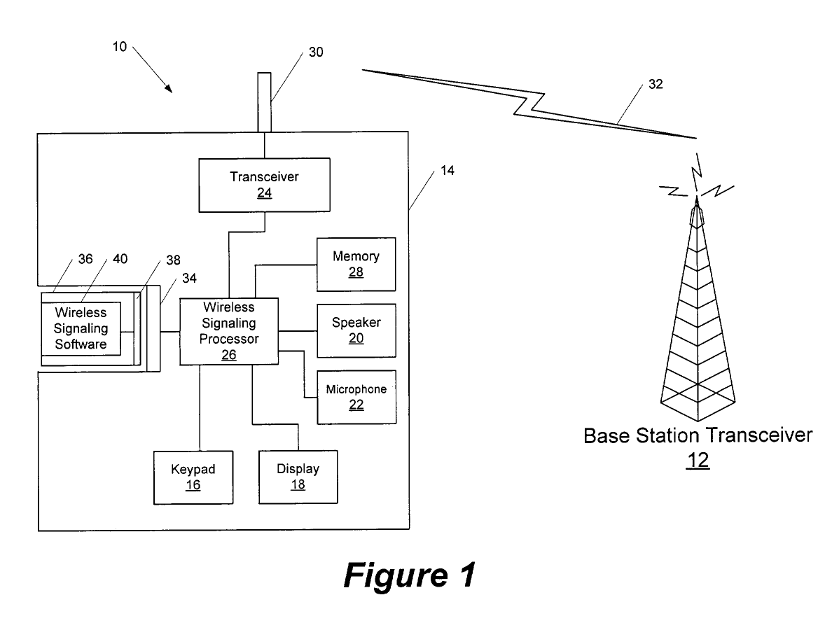

Various embodiments of the present invention will now be described with reference to the schematic block diagram of FIG. 1 that illustrates an exemplary radiotelephone communication system that includes a wireless mobile terminal 10 and a base station transceiver 12 of a wireless communications network. As illustrated in FIG. 1, the mobile terminal 10 includes a portable housing 14 and may include input/output devices, such as a keyboard/keypad 16, a display 18, a speaker 20, and microphone 22. The mobile terminal 10 also includes a wireless signaling processor 26 and at least one non-volatile memory 28, and may include a transceiver 24.

The non-volatile memory 28 may include one or more EEPROM, flash EEPROM, battery backed RAM, or other digital storage device, and may be separate from, or at least partially within, the wireless signaling processor 26. The transceiver 24 typically includes both a transmitter and a receiver to allow two way communications, but the present invention is not limited to such devices and, as used herein, a “transceiver” may include both a receiver and a transmitter or only one such communication circuit. The mobile terminal 10 may, thereby, communicate with the base station transceiver 12 using radio frequency signals. The radio frequency signals may be communicated through an antenna 30 over at least one communication channel 32 with the base station transceiver 12.

The wireless signaling processor 26 may support various communication related functions of the mobile terminal 26 that are defined by wireless signaling software in the memory 28. Operating according to the wireless signaling software, the wireless signaling processor 26 formats communication signals for transmission over the communication channel 32 according to a wireless communication protocol. The wireless communication protocol may include operations for establishing the communication channel 32 as a communication connection with the base station transceiver 12, maintaining the communication connection, formatting voice (speech) signals from the microphone 22 to digital communication signals that are suitable for transmission over the communication channel 32 (i.e., voice coding), and/or formatting voice signals that are received over the communication channel 32 to a form suitable for output by the speaker 20 (i.e., voice decoding). The formatted communication signals may include both traffic (voice and/or data) and control signals (e.g., paging signals/messages for incoming calls). Examples of wireless communication protocols for use with embodiments of the present invention include, ANSI-136, GSM, code division multiple access (CDMA), wideband-CDMA, CDMA2000, Enhanced Data rates for GSM Evolution (EDGE), Universal Mobile Telecommunications System (UMTS), Bluetooth, and wireless local area network (WLAN) protocols, including IEEE 802.11b, and the like. These and other wireless communication protocols are well known to those of skill in the art and will not be further described herein.

The wireless signaling processor 26 be one or more processors and may support additional functions such as email, games, a digital camera, and MP3 music.

The foregoing components of the mobile terminal 10, may be included in many conventional mobile terminals and their functionality is generally known to those skilled in the art. It should be further understood, that, as used herein, the term “mobile terminal” may include a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop portable computer that includes a radiotelephone transceiver.

According to embodiments of the present invention, the mobile terminal 10, as illustrated in FIG. 1, further includes an interface port 34 that is configured to receive, and communicate with, a removable memory module 36. The removable memory module 36 may include an interface 38 that is configured to communicatively couple to the interface port 34 of the mobile terminal 10. The removable memory module 36 also includes wireless signaling software 40 that may define a wireless communication protocol for establishing and/or maintaining a communication connection with a base station transceiver, and/or operations for formatting voice signals that are transmitted and/or received over the communication connection. The wireless signaling software 40 may also define operations for accessing a phone book that is internal to the mobile terminal 10, and/or for generating, receiving, and/or displaying on the display 18 short message service messages, emails, data, digital pictures, and/or video.

The wireless signal processor 26 is configured to transfer the wireless signaling software 40 from the removable memory module 36 to the memory 28. The wireless signal processor 26 is further configured to format communication signals according to the wireless signal program for transmission by the mobile terminal 10 over the communication channel 32. The wireless signaling processor 26 may execute the wireless signaling software 40 (e.g., performing compiled instructions or interpreting commands) in the at least one memory to format the communication signals. The transferred wireless signaling software 40 may at least partially replace wireless signaling software that may already be in the memory 28.

In this manner, the wireless signaling software that is used by the mobile terminal 10 to communicate over the wireless communication channel 32 may be loaded from the removable memory module 36. A manufacturer of cellular phones and/or a cellular service provider may, for example, distribute a cellular signaling program for a cellular phone on a removable memory module. The removable memory module may be mailed to a technician or to a subscriber, and/or the wireless signaling software may be downloaded from an Internet website, or direct dial connection, to the removable memory module and installed by a technician or by a subscriber. The technician or subscriber may then insert the removable memory module into a cellular phone to initially program and/or update the wireless signaling software in the cellular phone. Distribution and loading of the wireless signaling software from a removable memory module may enable more rapid programming of cellular phones, and may simplify the distribution and/or installation of wireless signaling software.

The wireless signal processor 26 may preclude or stop formatting communication signals while the wireless signal processor 26 transfers the wireless signaling software 40 from the removable memory module 36 to the memory 28. Because the wireless signal program 40 may at least partially replace existing wireless signaling software in the memory 28, during the transfer, the memory 28 may contain an incomplete combination of the existing and transferred wireless signal program. If the wireless signal processor 26 were to operate according to such an incomplete combination, incorrectly formatted communication signals may result. Accordingly, it may be advantageous for the wireless signal processor 26 to preclude/stop formatting communication signals until the completion of the transfer of the wireless signal program 40 to the memory 28. Alternatively, and for similar reasons, the wireless signal processor 26 may preclude transferring of the wireless signaling software 40 from the removable memory module 36 to the memory 28 when communication signals are being formatted for transmission.

The removable memory module 36 may be, for example, a Memory Stick (including Memory Stick Duo) card, a Smart Media card, a compact flash card, Multi Media card, Secure Digital card, a Smart Card device, and/or another storage device capable of storing the wireless signaling software.

The wireless signal processor 26 may transfer the wireless signaling software 40 responsive to a determination of whether the removable memory module 36 is communicatively coupled to the interface port 34. The determination may be responsive to a signal that is communicated by the interface port 34 when it is communicatively coupled to the removable memory module 36, and/or may be responsive to an attempt by the wireless signaling processor 26 to access the wireless signaling software 40 on the removable memory module 36.

The wireless signal processor 26 may determine whether the wireless signaling software 40 on the removable memory module 36 is authentic, and may transfer the wireless signaling software 40 only when it is authentic. The determination of authenticity may prevent the loading of wireless signaling software that is intended for a different type of mobile terminal, and/or prevent the loading of wireless signaling software that has been developed, or modified, by a non-authorized individual or entity.

The determination of authenticity may be responsive to a comparison of information on the memory module 36 with an authentication code in the memory 28. The authentication information on the memory module 36 may be included within the wireless signaling software 40. The authentication code in the memory 28 may include a digital pattern, sequence of patterns, and/or a computational result. The authentication code may identify a manufacturer of the mobile terminal, a model type of the mobile terminal (e.g., product model number or product family identity), and/or may uniquely identify the mobile terminal 10 (e.g., mobile identification number or serial number).

The wireless signaling software 40 on the removable memory module 36 may be encrypted with a conventional encryption algorithm or process. The determination of authenticity by the wireless signal processor 26 may include properly decrypting the wireless signaling software 40.

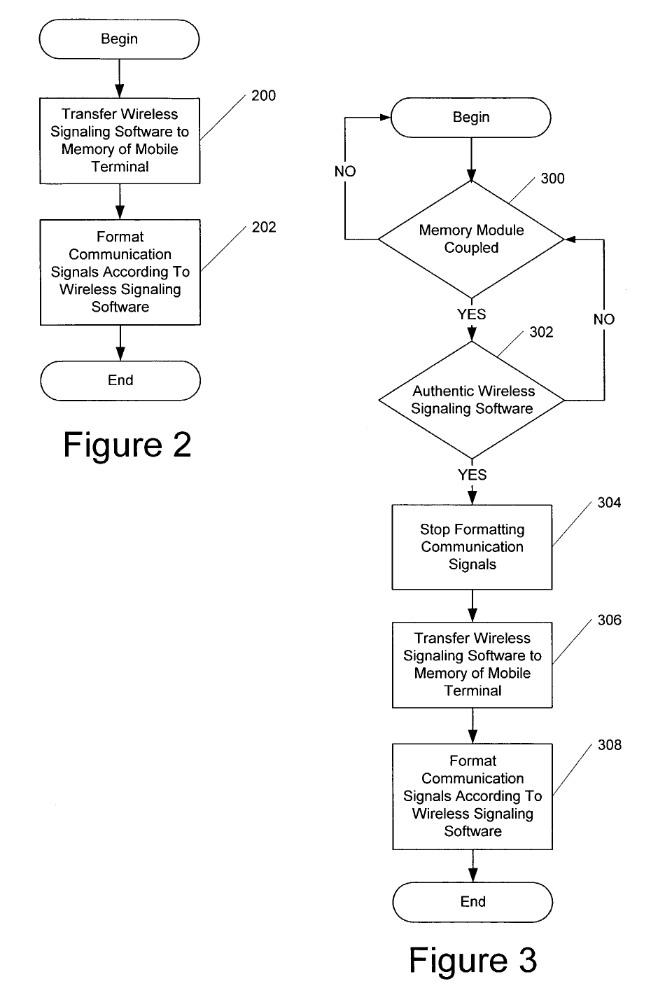

Operations related to configuring a mobile terminal that receives and uses a removable memory module, according to some embodiments of the present invention, will now be described with reference to the flow chart illustration of FIG. 2. As shown in FIG. 2, operations begin at Block 200 by transferring wireless signaling software from a removable memory module to a memory of the mobile terminal. At Block 202, communication signals are formatted according to the wireless signaling software for transmission by the mobile terminal over at least one wireless communication channel.

FIG. 3 illustrates other embodiments of operations that may be performed by a mobile terminal according to the present invention. At Block 300, a determination is made as to whether a removable memory module is communicatively coupled to the mobile terminal. When a removable memory module is coupled, a determination is made as to whether the wireless signaling software is authentic (Block 302). When the wireless signaling software is determined to be authentic at Block 302, formatting of communication signals is stopped at Block 304. Wireless signaling software is transferred from a removable memory module to a memory of the mobile terminal at Block 306, and, at Block 308, communication signals are formatted according to the wireless signaling software for transmission by the mobile terminal over at least one wireless communication channel.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A mobile terminal comprising:
a portable housing;
at least one memory in the housing;
an interface port in the housing that is configured to receive a removable memory module; and
a wireless signaling processor in the housing that is connected to the interface port to communicate with a received removable memory module, wherein the wireless signaling processor is configured to transfer wireless signaling software from a received removable memory module coupled to the interface port to the at least one memory, and is configured to format communication signals according to the wireless signaling software for transmission by the mobile terminal over at least one wireless communication channel.

2. The mobile terminal of claim 1 wherein the wireless signaling processor executes the wireless signaling software in the at least one memory to format communication signals.

3. The mobile terminal of claim 1 wherein the wireless signaling processor formats communication signals according to a wireless communication protocol defined by the wireless signaling software.

4. The mobile terminal of claim 3 wherein the wireless signaling processor establishes a communication connection over the at least one wireless communication channel with a base station transceiver according to the wireless communication protocol defined by the wireless signaling software.

5. The mobile terminal of claim 3 wherein the wireless signaling processor maintains communication over the at least one wireless communication channel with a base station transceiver according to the wireless communication protocol defined by the wireless signaling software.

6. The mobile terminal of claim 3 wherein the wireless signaling processor formats voice signals for communication over the at least one wireless communication channel according to the wireless communication protocol defined by the wireless signaling software.

7. The mobile terminal of claim 1 further comprising a transceiver communicatively coupled to the wireless signaling processor, wherein the transceiver is configured to communicate communication signals on the at least one wireless communication channel.

8. The mobile terminal of claim 1 wherein the interface port is configured to receive a memory stick.

9. The mobile terminal of claim 1 wherein the interface port is configured to receive at least one of a smart media card, a compact flash card, multi media card, secure digital card, or a smart card.

10. The mobile terminal of claim 1 wherein the wireless signaling processor is further configured to stop formatting communication signals for transmission by the mobile terminal while wireless signaling software is transferred from a removable memory module coupled to the interface port to the at least one memory.

11. The mobile terminal of claim 1 wherein the wireless signaling processor is configured to determine whether the wireless signaling software on a received removable memory module is authentic, and to transfer the wireless signaling software from the received removable memory module to the at least one memory only when the wireless signaling software is determined to authentic.

12. The mobile terminal of claim 11 wherein the wireless signaling processor is configured to determine whether the wireless signaling software is authentic by comparing information on a received removable memory module to an authentication code in the at least one memory.

13. The mobile terminal of claim 12 wherein the authentication code identifies a manufacturer of the mobile terminal.

14. The mobile terminal of claim 12 wherein the authentication code identifies a model type of the mobile terminal.

15. The mobile terminal of claim 12 wherein the authentication code uniquely identifies the mobile terminal.

16. The mobile terminal of claim 1 wherein the wireless signaling processor is configured to decrypt the wireless signaling software.

17. The mobile terminal of claim 1 wherein the at least one memory is a non-volatile memory.

18. The mobile terminal of claim 1 wherein the wireless signaling processor stores and retrieves telephone numbers from a phone book according to operations defined by the wireless signaling program.

19. The mobile terminal of claim 1 wherein the wireless signaling processor receives and displays data and digital pictures according to operations defined by the wireless signaling program.

20. A method of programming a mobile terminal that is communicatively coupled to a removable memory module, the method comprising:
transferring wireless signaling software from the removable memory module to at least one memory in the mobile terminal; and
formatting communication signals according to the wireless signaling software in the least one memory for transmission by the mobile terminal over at least one wireless communication channel.

21. The method of claim 20 wherein the formatting communication signals comprises executing the wireless signaling software in the at least one memory.

22. The method of claim 20 wherein formatting communication signals comprises communicating with a wireless communication protocol defined by the wireless signaling software.

23. The method of claim 22 wherein formatting communication signals comprises establishing a communication connection over a wireless communication channel with a base station transceiver according to the wireless communication protocol defined the wireless signaling software.

24. The method of claim 22 wherein formatting communication signals comprises maintaining a communication connection over a wireless communication channel with a base station transceiver according to the wireless communication protocol defined the wireless signaling software.

25. The method of claim 22 wherein formatting communication signals comprises formatting voice signals according to the wireless communication protocol defined the wireless signaling software.

26. The method of claim 20 further comprising precluding formatting of communication signals while transferring the wireless signaling software from a removable memory module to the at least one memory.

27. The method of claim 20 further comprising determining whether the wireless signaling software is authentic, and wherein formatting communication signals is responsive to determining whether the wireless signaling software is authentic.

28. The method of claim 27 wherein determining whether the wireless signaling software is authentic comprises comparing information from the removable memory module to an authentication code in the mobile terminal.

29. The method of claim 28 wherein the authentication code identifies a manufacturer of the mobile terminal.

30. The method of claim 28 wherein the authentication code identifies a model type of the mobile terminal.

31. The method of claim 28 wherein the authentication code uniquely identifies the mobile terminal.

32. The method of claim 20 wherein determining whether the wireless signaling software is authentic comprises decrypting the wireless signaling software.
